(19) United States
(12) Patent Application Publication
(10) Pub. No.: US 2019/0144057 A1
(43) Pub. Date: May 16, 2019

(54) BULL BAR SUPPORT ARRANGEMENT

(71) Applicant: Benjamin KUNKEL, Victoria (AU)

(72) Inventor: Jeffrey Kunkel, Victoria (AU)

(21) Appl. No.: 16/249,167

(22) Filed: Jan. 16, 2019

Related U.S. Application Data
(63) Continuation-in-part of application No. PCT/AU2017/050735, filed on Jul. 16, 2017.

(51) Int. Cl. B62D 65/16

(52) U.S. Cl. CPC B62D 65/16

(57) ABSTRACT

The Bull Bar Assist comprises of a vertical steel square frame welded to two horizontal angle iron supports. Vertical bars have adjustable support bars attached for variable heights to position bull bar. Velcro straps connect the top horizontal bar to the bull bar. The Bull Bar Assist is fastened to a mobile hydraulic scissor lift for easy access and mobility. Without the assist fastened to the scissor lift it will not work as designed. The item can be made out of square metal tubing and angle iron, with rubber stoppers for protection.

### CROSS-REFERENCE TO RELATED APPLICATIONS

This application claims priority from PCT/AU2017/050735 the contents of which are incorporated by reference.

### FIELD OF THE INVENTION

The present invention relates to the mounting and removal of bull bars (and accessories in general) to vehicles and in particular for mounting bull bars to 4WD vehicles.

The invention has been developed primarily for use with recreational vehicles such as 4WD's and will be described hereinafter with reference to this application. However, it will be appreciated that the invention is not limited to this particular field of use.

### BACKGROUND OF THE INVENTION

Presently, bull bars and other vehicle accessories are removed and/or mounted to a vehicle using multiple people involving a significant amount of ‘man handling’ and presenting occupational health and safety issues due to the weight and bulk of the bull bar.

The present invention seeks to provide an alternative to current methods for mounting bull bars (and generally accessories) to vehicles, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in America or any other country.

### SUMMARY OF THE INVENTION

In accordance with the present invention, the inventor has devised a vehicle accessory support apparatus that allows a user to mount vehicle accessories, and in particular heavy and bulky accessories, such as bull bars and tow bars, to a vehicle avoiding the need for more than one person to perform the task. This is achieved using a combination of a lifting mechanism and an attachment arrangement for accurately positioning and attaching said vehicle accessories to the vehicle.

According to a first aspect, the present invention may be said to consist of a vehicle accessory support apparatus suitable for aid in the removal and/or installation of a bull bar associated with a vehicle, the apparatus comprising:
a. a frame, the frame being adapted for secure attachment to a lifting mechanism;
b. the frame including at least one or more attachment formations configured for attachment of at least one or more tensioning members between the frame and the bull bar in use;
c. at least one adjustable engaging member including at least one abutment formation for abutting the bull bar in use, the engaging member being moveably attached to the frame in an adjustable fashion by an adjustment mechanism; and
d. wherein, in use, at least one or both of the at least one adjustable engaging member and the at least one or more tensioning members are adjustable in length to thereby adjust the orientation of the bull bar to facilitate installation of the bull bar on the vehicle.

In one embodiment, the vehicle accessory support apparatus includes at least one or more tensioning members.

In one embodiment, the attachment formations are located at a level above the at least one abutment formation.

In one embodiment, the at least one adjustable engaging member is elongate.

In one embodiment, the at least one adjustable engaging member is moveable in a substantially horizontal direction.

In one embodiment, the frame is releasably attachable to the lifting mechanism.

In one embodiment, the at least one or more tensioning members are adjustable straps.

In one embodiment, the support apparatus includes a lifting mechanism.

In one embodiment, the lifting mechanism is a scissor lift.

In one embodiment, the lifting mechanism is hydraulically operated.

In one embodiment, the scissor lift is hydraulically operated using a foot pedal.

In one embodiment, the at least one member is adjustable using clamp joints.

In one embodiment, the at least one elongate support member further comprises rubber stoppers at at least one end of the at least one elongate support member.

In one embodiment, the adjustment mechanism includes a threaded fastener.

In one embodiment, the scissor lift includes a support platform for supporting the weight of the bull bar in use.

In one embodiment, the apparatus includes a support formation adapted for attachment to the scissor lift, the support formations being configured for supporting vehicle accessories.

In one embodiment, the frame includes a securing arrangement for securing the frame to the scissor lift.

In a further aspect, the present invention may comprise a vehicle accessory support apparatus suitable for aid in the removal and/or installation of a bull bar associated with a vehicle, the apparatus comprising:
e. a frame, the frame being adapted for secure attachment to a lifting mechanism;
f. at least one or more tensioners attachable to the frame,
   i. the at least one or more tensioners being configured for attachment to the bull bar in use, and
   ii. the at least one or more tensioners being configured to pull the bull bar towards the frame in use;
g. at least one compression member attachable to the frame, the compression member including at least one abutment formation for abutting the bull bar in use to resist the tension of the tensioners,
h. wherein at least one or both of the tensioners and the compression member are adjustable in length to thereby adjust the orientation of the bull bar to facilitate installation of the bull bar.

In one embodiment, the compression member is an elongate adjustable engaging member including at least one abutment formation for abutting the bull bar in use.

In one embodiment, the compression member is adjustable to move substantially linearly.

In one embodiment, the compression member is adjustably movable in a horizontal direction in use.

In one embodiment, the tensioners are flexible elongate members.

In one embodiment, the tensioners are adjustable straps.

According to yet a further aspect, the present invention may comprise a vehicle accessory support apparatus suitable for aid in the removal and/or installation of a bull bar associated with a vehicle, the apparatus comprising:
i. a frame, the frame being adapted for secure attachment to a lifting mechanism; the frame including
   i. at least one or more attachment formations configured for attachment of at least one or more tensioning members between the frame and the bull bar in use;
j. at least one horizontally adjustable engaging member including at least one abutment formation for abutting the bull bar in use, the engaging member being moveably attached to the frame in an adjustable fashion by an adjustment mechanism; and
k. wherein, in use, the at least one adjustable engaging member is adjustable in length to thereby adjust the orientation of the bull bar to facilitate installation of the bull bar.

In one embodiment, the lifting mechanism includes a handle to aid in the movement of the lifting mechanism.

In one embodiment, the handle is removable from the lifting mechanism.

In one embodiment, the handle is detachable from the lifting mechanism.

In one embodiment, the handle comprises a grip to aid in the movement of the lifting mechanism.

In one embodiment, the lifting mechanism comprises wheels.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is perspective view of an embodiment of the invention;

FIG. 2 is perspective view of a frame in accordance with an embodiment of the invention;

FIG. 3 is a detailed view of a support formation in accordance with an embodiment of the invention;

FIG. 4 is a front perspective view of the embodiment of the invention shown in FIG. 1 in use with a bull bar;

FIG. 5 is a rear perspective view of an embodiment of the invention shown in FIG. 1 in use with the bull bar; and

FIG. 6 is a side view of an embodiment of the invention shown in FIG. 1 in use with the bull bar.

### DESCRIPTION OF EMBODIMENTS

It should be noted in the following description that like or the same reference numerals in different embodiments denote the same or similar features.

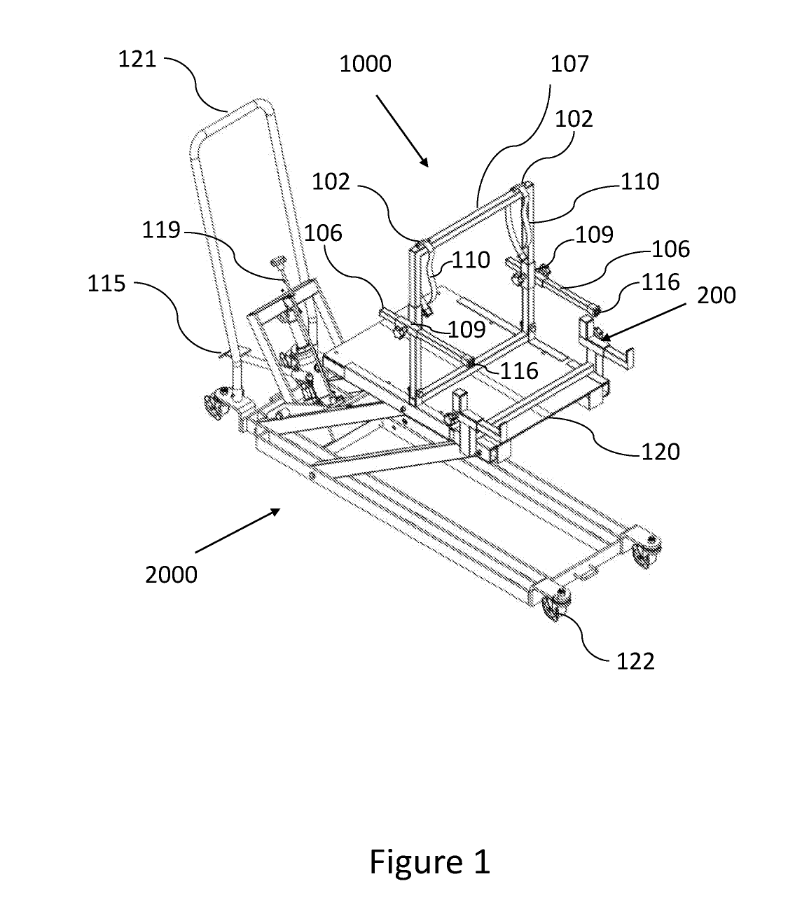

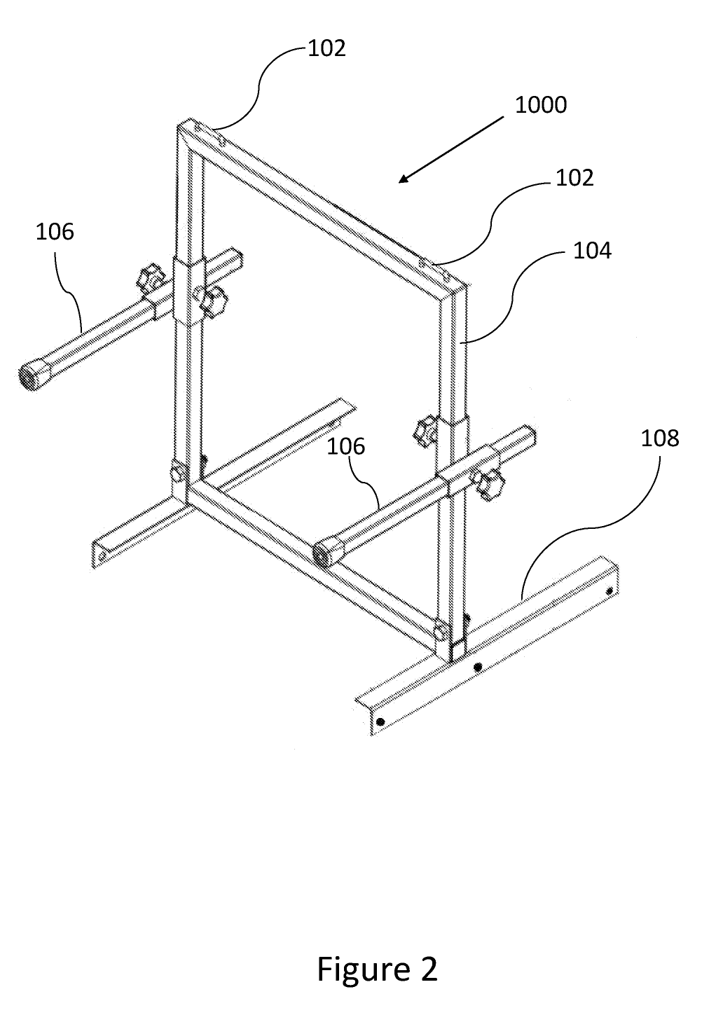

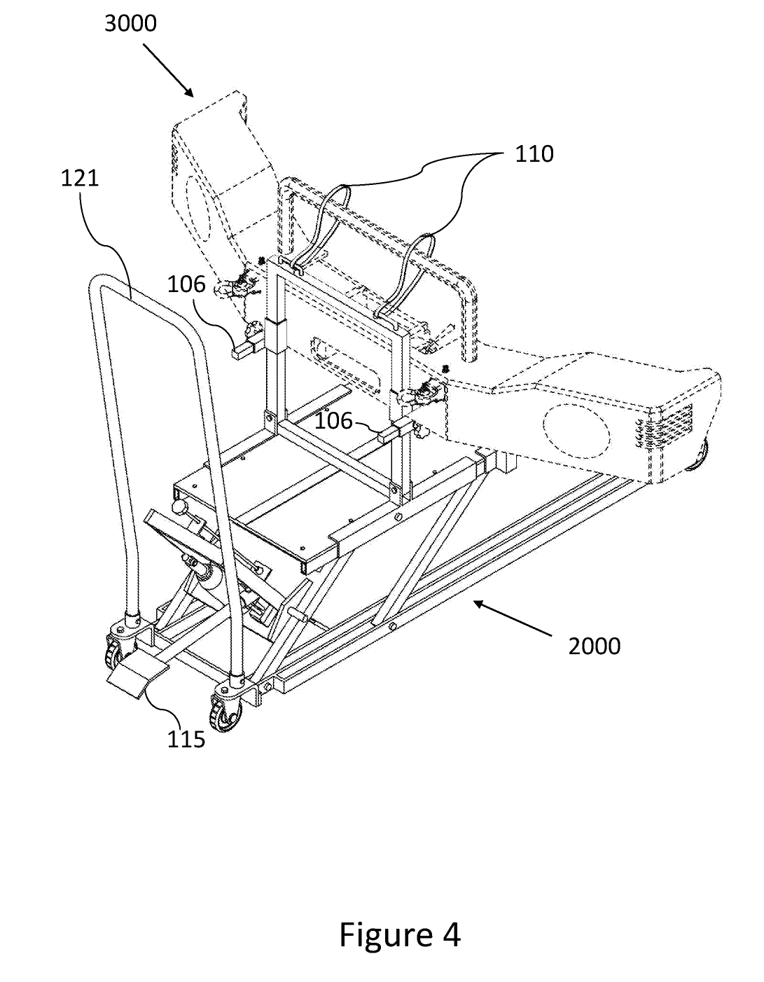

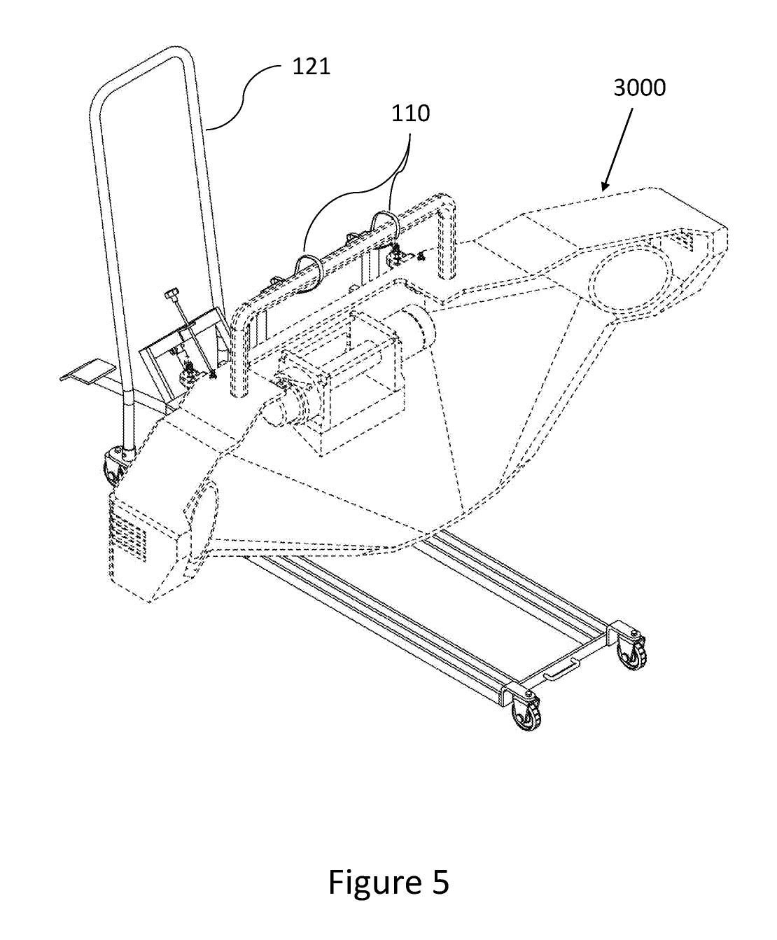

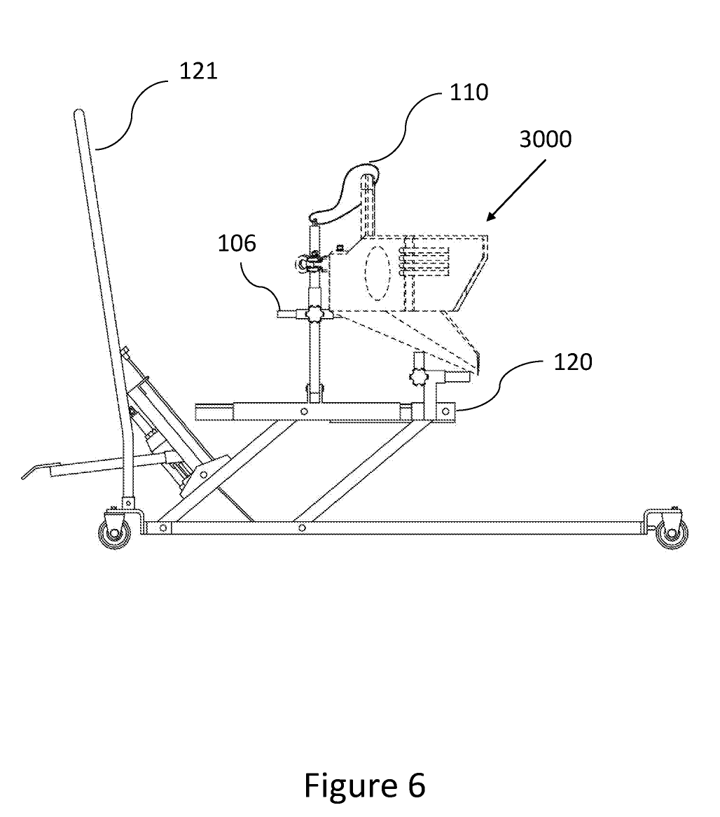

FIGS. 1 to 3 are directed to embodiments of the invention without the bull bar 3000 attached and FIGS. 4 to 6 exemplify an embodiment of the invention in use in the fitment of a bull bar 3000.

In FIG. 1 a vehicle accessory support apparatus suitable for aid in the removal and/or installation of a bull bar associated with a vehicle according to an aspect of the invention is generally indicated by the numeral 1000 and will herein be referred to as the support apparatus 1000.

In one embodiment now described, the support apparatus 1000 comprises a frame 107 which is adapted for attachment to a lifting mechanism 2000, which in this embodiment is a hydraulically operated scissor lift 2000. In alternative embodiments, the support apparatus 1000 and the lifting mechanism 2000 may be incorporated as one unit permanently attached to each other, however in the embodiment shown the support apparatus 1000 and the lifting mechanism 2000 are detachable from each other and may be sold separately. In this case, the user may use their own existing lifting mechanism 2000 rather than purchase a new one for use with the support apparatus 1000.

It will be appreciated by a person skilled in the art that the scissor lift 2000 may be replaced by other suitable lifting mechanisms such as a hydraulic ram or a thread and gear arrangement as examples. Furthermore, the hydraulic actuation may be replaced by a threaded rod and threaded nut actuating arrangement, wherein the threaded rod may be rotated within a stationary threaded nut to produce movement of the scissor lift structure which could be attached to one end of the threaded bolt. The rotation of the threaded rod resulting in either the up or down direction dependent on the direction of rotation of the threaded rod.

Attached to the frame 107 is at least one or more attachment formations 102, adapted to locate at least one or more tensioning members 110 (also referred to as tensioners), which in the embodiment shown are flexible straps comprising of adjustment buckles, allowing for the flexible strap 110 to be adjusted in length. The attachment formations 102 are adapted to locate the one or more tensioning members 110 on the frame 107 by preventing sliding movement of the tensioning members 110 along the length of the frame 107.

It is envisaged that the tensioning members 110 may be made from a variety of flexible materials as will be explained below.

The attachment formations 102 may take the form of a formation in the shape of a handle through which the tensioning members 110 may be threaded. It is envisaged that the attachment formations 102 would be attached to the frame 107 using either screws, a nut and bolt combination or alternatively pop rivets. The attachment formations 102 would be preferably made of steel or aluminium providing for durability and strength, however in alternative embodiments the attachment formations 102 may be manufactured from a variety of different polymers as an alternative to metallic structures.

As is shown in FIGS. 4 to 6, the at least one or more tensioning members 110 are intended to be wrapped around an appropriate section of the bull bar 3000 providing stability and allowing for fine adjustment of the angle of the bull bar 3000 in relation to the vehicle, allowing for the precise location of the bull bar 3000 in relation to the vehicle (not shown).

In one embodiment, the at least one or more tensioning members 110 may be adjustable straps, which may take the form of Velcro™ straps or straps that make use of either a buckle or ratchet mechanism to aid in the tensioning of the straps. In alternative embodiments, the tensioning members 110 may take a rigid non-flexible form such as a metallic locking mechanism.

At least one adjustable engaging member 106 (also referred to as a compression member) is moveably attached to the frame 107 using an adjustment mechanism 109. The adjustment mechanism 109 may comprise a clamping mechanism, such as clamp joints that are adapted to apply an adjustable clamping force between the frame 107 and the adjustable engaging member 106, allowing for movement of the adjustable engaging member 106 in relation to the frame 107 in more than one direction. The adjustment mechanism 109 may alternatively include a threaded fastener for securely attaching the engaging members 106 to the frame 107.

The adjustable engaging member 106 further includes at least one abutment formation 116. The abutment formation 116 is adapted to abut against the bull bar 3000 when being removed or installed. The abutment formation 116 is preferably made of a non-rigid material such as rubber in the form of rubber stoppers which can also provide a degree of friction, while at the same time, the non-rigid material prevents damage to the bull bar, which is particularly relevant if the bull bar 3000 is painted.

The support apparatus 1000 may be supplied with or without the tensioning members 110, where in one embodiment the user may choose their own tensioning members 110 dependent on the user's application.

The attachment formations 102 are located above the height of the at least one abutment formation 116 in the embodiment shown, this is preferable as it facilitates easy adjustment of the position of the bull bar 3000 in reference to the vehicle allowing for fine adjustment of the bull bar 3000 for mounting to the vehicle. It is envisaged that the attachment formation 102 may be located below the height of the at least one abutment formation 116 whilst still maintaining the ability for adjustment of the bull bar 3000.

In the embodiment shown in the figures, the at least one adjustable engaging member 106 is elongate in shape, however it is envisaged that the at least one adjustable engaging member 106 may take a generally non-linear form such as a curved form.

The at least one adjustable engaging member 106 is adapted for movement in a substantially horizontal direction, however it is envisaged that in alternative embodiments that the movement of the at least one adjustable engaging member 106 may move in a direction that is angled away from the horizontal direction, while achieving the same ability to accurately positon the bull bar 3000 in place in relation to the vehicle, which is particularly important when mounting the bull bar 3000 to the vehicle.

In the embodiment shown it is envisaged that the lifting mechanism 2000 may take the form of an off-the-shelf lifting mechanism and the support apparatus 1000 may be sold separately to the lifting mechanism 2000, this may be particularly advantageous if the operator already has a suitable lifting mechanism such as a scissor lift in their possession. Alternatively, the support apparatus 1000 and the lifting mechanism 2000 may be sold together. In the embodiment shown, the lifting mechanism 2000 is releasably attachable to the frame allowing for interchangeability.

The lifting mechanism 2000 is not only adapted to take the weight of the bull bar, the lifting mechanism 2000 is used to align the bull bar 3000 to the vehicle by appropriately adjusting the height of the bull bar 3000 to the vehicle upon fitment. Preferably, the lifting mechanism 2000 is hydraulically operated allowing the operator to lift and adjust the height of the bull bar 3000 in relation to the vehicle with minimal physical strain on the user due to the force amplification provided by the hydraulic operation. In the embodiment shown a foot pedal 115 is used to operate the hydraulic unit assembly. The foot pedal 115 provides leverage for the user and is convenient especially if the user is using their hands to manoeuvre the lifting mechanism 2000 in place. In order to lower the height of the lifting mechanism 2000 a release knob 119 is provided which is adapted for rotation in order to reduce the hydraulic pressure in the system in order for the lifting mechanism 2000 to lower in height.

In alternative embodiments, the lifting mechanism 2000 and the support apparatus 1000 may be sold as one unit. In the embodiment shown the lifting mechanism 2000 which is a scissor lift in this embodiment. includes a support platform 120 which is designed to support the weight of the bull bar 3000 upon removal and/or installation from the vehicle.

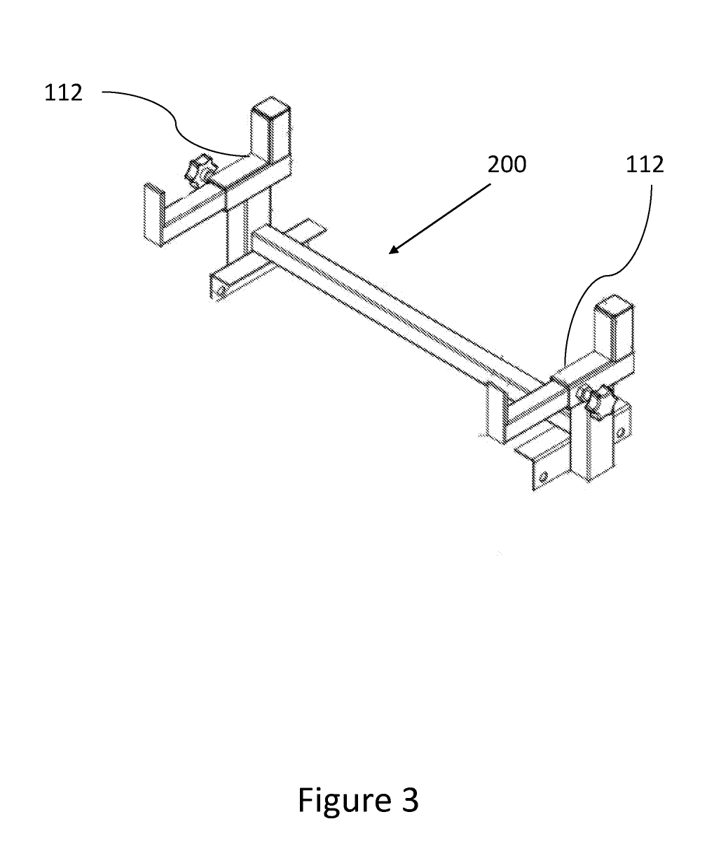

As is shown in FIG. 3 an additional attachment in the form of a support formation 200 may be attached to the support platform 120 to aid in the installation of accessories in addition to bull bars to the vehicle. The support formation 200 is removably attachable to the support platform 120. either slidably on a set of rails attached to the support formation 200 or alternatively the support formation 200 may be bolted to the support platform 120. The support formation 200 is adapted for holding a variety of different vehicle accessories and/or components for mounting to the vehicle such as tow bars and the like. The support formation 200 comprises at least two adjustable arms 112 that may be adjusted to facilitate the shape of the accessory being mounted to the support formation 200. It is envisaged that the adjustable arms 112 would be adjustable by a clamping arrangement similar to the adjustment mechanism 109 as is used in relation to the frame 107 and the adjustable engaging member 106.

When in use, the operator would place the bull bar 3000 on the platform 120 and adjust the positions of the engaging members 106 with the aid of the adjustment mechanism 109, which is adapted to allow for at least both up and down movement in the vertical plane of the engaging members 106 and movement along the horizontal plane of the engaging members 106, Fine adjustment of the position of the bull bar 3000 may be achieved through the combination of the positioning of the engaging members 106 and the tensioning of the tensioning members 110 in order to adjust the angle of the bull bar 3000 in relation to the vehicle that it is attached to. The height of the lifting mechanism 2000 (and hence the attached bull bar) is adjusted by the use of the foot pedal 115 in order to raise the height of the platform 120 the desired height for mounting the bull bar 3000 to the vehicle. The height of the platform is lowered by adjusting the release knob 119 by rotating the release knob 119 in either a clockwise or anti-clockwise direction in order to lower the platform to the desired height.

To aid in the movement of the lifting mechanism 2000 the lifting mechanism comprises wheels 122, The wheels 122 may take the form of castor wheels which are alternatively lockable into place using wheel locking mechanisms that are known in the art.

A handle 121 is attached to the lifting mechanism to allow the lifting mechanism to be moved into position. It is envisaged that the handle 121 may be detachable from the lifting mechanism aiding in storage and positioning of the lifting mechanism 2000 into tight places. In other embodiments, the handle 121 comprises a grip to facilitate the movement of the lifting mechanism 2000 into position.

### Interpretation

### Bull Bar

The term bull bar within the specification is taken to mean its dictionary meaning which is a metal frame fixed in front of the front lights of a vehicle to prevent serious damage if the vehicle hits an animal. Alternative terms used for a bull bar include, inter alia ‘grille guard’, ‘rammer’ or ‘cattle pusher’.

### Markush Groups

In addition, where features or aspects of the invention are described in terms of

Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent o one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Industrial Applicability

It is apparent from the above, that the arrangements described are applicable to the automotive accessory industries.

The claims defining the invention are as follows:

1. A vehicle accessory support apparatus suitable for aid in the removal and/or installation of a bull bar associated with a vehicle, the apparatus comprising:
a. a frame, the frame being adapted for secure attachment to a lifting mechanism;
b. the frame including at least one or more attachment formations configured for attachment of at least one or more tensioning members between the frame and the bull bar in use;
c. at least one adjustable engaging member including at least one abutment formation for abutting the bull bar in use, the at least one adjustable engaging member being moveably attached to the frame in an adjustable fashion by an adjustment mechanism; and
d. wherein, in use, at least one or both of the at least one adjustable engaging member and the at least one or more tensioning members are adjustable in length to thereby adjust the orientation of the bull bar to facilitate installation of the bull bar on the vehicle.

2. The vehicle accessory support apparatus of claim 1, wherein the vehicle accessory support apparatus includes at least one or more tensioning members.

3. The vehicle accessory support apparatus of claim 1, wherein the attachment formations are located at a level above the at least one abutment formation.

4. The vehicle accessory support apparatus of claim 1, wherein the at least one adjustable engaging member is elongate.

5. The vehicle accessory support apparatus of claim 1, wherein the at least one adjustable engaging member is moveable in a substantially horizontal direction.

6. The vehicle accessory support apparatus of claim 1, wherein the frame is releasably attachable to the lifting mechanism.

7. The vehicle accessory support apparatus of claim 1, wherein the at least one or more tensioning members are adjustable straps.

8. The vehicle accessory support apparatus of claim 1, wherein the support apparatus includes a lifting mechanism.

9. The vehicle accessory support apparatus of claim 1, wherein the lifting mechanism is a scissor lift.

10. The vehicle accessory support apparatus of claim 6, wherein the lifting mechanism is hydraulically operated.

11. The vehicle accessory support apparatus of claim 7, wherein the scissor lift is hydraulically operated using a foot pedal.

12. The vehicle accessory support apparatus of claim 1, wherein the at least one member is adjustable using clamp joints.

13. The vehicle accessory support apparatus of claim 1, wherein the at least one elongate support member further comprises rubber stoppers at at least one end of the at least one elongate support member.

14. The vehicle accessory support apparatus of claim 1, wherein the adjustment mechanism includes a threaded fastener.

15. The vehicle accessory support apparatus of claim 1, wherein the scissor lift includes a support platform for supporting the weight of the bull bar in use.

16. The vehicle accessory support apparatus of claim 1, further including a support formation adapted for attachment to the scissor lift, the support formations being configured for supporting vehicle accessories.

17. The vehicle accessory support apparatus of claim 1, wherein the frame includes a securing arrangement for securing the frame to the scissor lift.

18. A vehicle accessory support apparatus suitable for aid in the removal and/or installation of a bull bar associated with a vehicle, the apparatus comprising:
a. a frame, the frame being adapted for secure attachment to a lifting mechanism;
b. at least one or more tensioners attachable to the frame,
i. the at least one or more tensioners being configured for attachment to the bull bar in use, and
ii. the at least one or more tensioners being configured to pull the bull bar towards the frame in use;
c. at least one compression member attachable to the frame, the compression member including at least one abutment formation for abutting the bull bar in use to resist the tension of the tensioners,
d. wherein at least one or both of the tensioners and the compression member are adjustable in length to thereby adjust the orientation of the bull bar to facilitate installation of the bull bar.

19. The vehicle accessory support apparatus of claim 18, wherein the compression member is an elongate adjustable engaging member including at least one abutment formation for abutting the bull bar in use.

20. The vehicle accessory support apparatus of claim 18, wherein the compression member is adjustable to move substantially linearly.

21. The vehicle accessory support apparatus of claim 18, wherein the compression member is adjustably movable in a horizontal direction in use.

22. The vehicle accessory support apparatus of claim 18, wherein the tensioners are flexible elongate members.

23. The vehicle accessory support apparatus of claim 18, wherein the tensioners are adjustable straps.

24. A vehicle accessory support apparatus suitable for aid in the removal and/or installation of a bull bar associated with a vehicle, the apparatus comprising:
a. a frame, the frame being adapted for secure attachment to a lifting mechanism; the frame including
i. at least one or more attachment formations configured for attachment of at least one or more tensioning members between the frame and the bull bar in use;
b. at least one horizontally adjustable engaging member including at least one abutment formation for abutting the bull bar in use, the engaging member being moveably attached to the frame in an adjustable fashion by an adjustment mechanism; and
c. wherein, in use, the at least one adjustable engaging member is adjustable in length to thereby adjust the orientation of the bull bar to facilitate installation of the bull bar.
